(19) United States
(12) Patent Application Publication
(10) Pub. No.: US 2002/0181419 A1
(43) Pub. Date: Dec. 5, 2002

(54) Method for handoff in multimedia wireless networks

(76) Inventors: Tao Zhang, Fort Lee, NJ (US); Eric van den Berg, Hoboken, NJ (US); Jasmine Chennikara, Morristown, NJ (US); Prathima Agrawal, New Providence, NJ (US)

Correspondence Address: Orville R. Cockings, Esq., Telcordia Technologies, Inc., 445 South Street, Room 1G112R, Morristown, NJ, 07960-6438, US

(21) Appl. No.: 09/872,213

(22) Filed: Jun. 1, 2001

(51) Int. Cl. H04L 12/66

(52) U.S. Cl. 370/331; 370/352

(57) ABSTRACT

A method for time series-based localized predictive resource reservation for handoff in multimedia wireless networks models the amount of network resources R(t) necessary to handoff a mobile terminal in a wireless IP network as an ARIMA (p,1,q) process. An ARIMA (p,1,q) process is a Weiner process wherein the future value of a stochastic variable depends only on its present value. The ARIMA (p,1,q) process includes an autocorrelation component, wherein the future value of a stochastic variable is based on its correlation to past values, and a moving average component that filters error measurements in past variable observations. Each wireless IP base station determines its own ARIMA (p,1,q) model and uses its model to locally predict the amount of network resources R(t) it needs to reserve for the handoff of mobile terminals.

### FIELD OF THE INVENTION

The present invention generally relates to the provision of services in mobile wireless Internet Protocol (IP) networks and more specifically relates to allowing mobility of service for subscribers in such wireless networks.

### BACKGROUND OF THE INVENTION

Two recent technological hallmarks have been the development of the personal computer and the wireless mobile telephone or cellular phone. The personal computer has enabled individuals to access and process large amounts of information for a wide variety of purposes which include communicating with other individuals, developing information for presentation to other individuals using different media formats, distributing information to a large number of individuals, and storing information for ease and efficiency. The cellular phone has allowed individuals to communicate information while roaming over large geographical areas, thereby increasing a user's access to information. In sum, the personal computer and cellular phone have greatly increased the ability of individuals to access and process information.

In addition to the personal computer and the cellular phone, the Internet has also been a revolutionary development in the area of information communication. The Internet is a packet data network in which Internet Protocol (IP) defines the manner in which a user connects to the Internet and communicates with other Internet users. When a user connects to the Internet, the user's IP terminal is assigned an IP address that enables the user to access the Internet and communicate information via the Internet. Users communicate with other users by sending information to and receiving information from the IP addresses of other users' terminals.

The combination of personal computer processing power and cellular phone mobility has enabled users to simultaneously access the Internet and roam over large geographical areas, thereby incorporating the benefits of the personal computer, cellular technology, and the Internet. In particular, wireless IP networks enable users to communicate with the Internet via a wireless connection between the user's mobile terminal and a wireless IP network, which is connected to the Internet. These wireless IP networks enable a user's mobile terminal to access the Internet and communicate information to the Internet while roaming over large geographical areas via the wireless connection between the mobile terminal and the wireless IP network.

Referring now to FIG. 1, therein is shown a wireless IP network wherein a plurality of mobile terminals communicate with a wireless IP network and the Internet while roaming over a geographical area. The wireless IP network shown includes a plurality of wireless IP base stations 4, 4′ and 4″ that use wireless techniques and IP to communicate information between the two mobile terminals 2 and 2′ shown and an IP backbone network 6. The mobile terminal 2 communicates information using wireless techniques and IP via the plurality of wireless connections 8 and 8′ between the mobile terminal 2 and the wireless IP base stations 4 and 4′, respectively. Similarly, the mobile terminal 2′ communicates information using wireless techniques and IP via the plurality of wireless connections 8″ and 8′″ between the mobile terminal 2′ and the wireless IP base stations 4 and 4′, respectively. IP backbone network connections 10 communicate information between the wireless IP base stations 4, 4′ and 4″ and the IP backbone network 6. Although two mobile terminals 2 and 2′ are shown, the wireless IP network can support a plurality of mobile terminals by allocating sufficient network resources to those mobile terminals it supports.

In order to establish a wireless connection, a mobile terminal 2 initially establishes a wireless network connection between itself and the wireless IP network via one of the wireless IP base stations (e.g., base station 4′) within the wireless IP network. The mobile terminal will acquire an IP address. This may be done using an IP-layer mobility management protocol, such as Mobile IP as defined by the Internet Engineering Task Force (IETF) in its Request For Comments (RFC) 2002. Alternatively, it may be achieved by any protocol for dynamic IP address assignment, such as the Dynamic Host Configuration Protocol (DHCP) as defined in IETF FRC 2131. The mobile terminal 2 uses to establish a wireless connection 8′ and communicate information between the wireless IP network and the mobile terminal 2. This mobile terminal 2 is a resident host because it is establishing its initial wireless connection 8′ in order to create a new overall wireless connection between the mobile terminal 2 and the wireless IP network. Thus, resident hosts request IP resources from the wireless IP network in order to establish an initial wireless connection between themselves and the wireless IP network.

After an initial wireless connection has been established between a mobile terminal and the wireless IP network, the mobile terminal may roam from its initial geographical location to another geographical location. As the mobile terminal roams, its preexisting wireless connection may become insufficient to communicate information between the mobile terminal and the wireless IP network. Thus, the existing wireless connection must be replaced with a new wireless connection between the mobile terminal and another wireless IP base station in order to maintain the existing overall wireless connection between the mobile terminal and wireless IP network.

This mobile terminal handoff process is the process wherein an existing wireless connection is replaced when the existing wireless connection with an old wireless IP base station is dropped and a new wireless connection with a new wireless IP base station is established in its place. The handoff of a mobile terminal can either be hard or soft. For a hard handoff, only one wireless connection is maintained at any one time and handed off throughout a mobile terminal's connection to the wireless IP network. Thus, a mobile terminal first establishes its initial wireless connection as a resident host. This initial wireless connection is then handed from one wireless IP base station to another wireless IP base station as the mobile terminal becomes a handoff host that roams from one location to another. The actual handoff of the existing wireless connection occurs when a single new wireless connection to a recipient wireless IP base station is established, and then the single existing wireless connection to the donor wireless IP base station is terminated.

When hard handoff occurs, it is essential for the recipient wireless IP base station to have sufficient network resources to allocate to the handoff host. If the recipient wireless IP base station is unable to allocate sufficient IP resources to accept the mobile terminal during hard handoff, then the quality of service for communicating information between the mobile terminal and CDMA IP network will decrease. If the recipient wireless IP base station is unable to allocate sufficient IP resources to establish a new wireless connection between itself and the handoff host, then the mobile terminal's existing, overall wireless connection between the mobile terminal and the CDMA IP network will be terminated because its only wireless connection will be dropped.

For a soft handoff, a plurality of wireless IP base stations simultaneously communicate with a mobile terminal via a plurality of wireless connections as handoff occurs. While one or more wireless connections between different wireless IP base stations are replaced with new wireless connections to new wireless IP base stations, other existing wireless connections are maintained. This enables the mobile terminal to seamlessly transit from one location to another while maintaining its overall wireless connection with the wireless IP network. Thus, soft handoff has an advantage over hard handoff in that it maintains an overall wireless connection comprised of a plurality of individual wireless connections, but the cost is the additional wireless connections between the mobile terminal and a plurality of wireless IP base stations.

Once again, if insufficient network resources exist to handoff the mobile terminal during soft handoff, the quality of service for the mobile terminal will decrease as the quality and quantity of the wireless connections between the mobile terminal and wireless decreases. Unlike hard handoff, the loss of any single wireless connection is not fatal, because other wireless connections remain between the mobile terminal and wireless IP network. Such losses will however, decrease the quality of service, however, because fewer wireless connections will exist to communicate information between the mobile terminal and the wireless IP network. Furthermore, if all the wireless connections are eventually lost, the overall wireless connection between the mobile terminal and the IP network will be terminated.

Whenever a mobile terminal attempts to establish a new wireless connection between itself and a wireless IP base station, the mobile terminal must request network resources from the wireless IP base station to establish a wireless connection between itself and the wireless IP base station. The mobile terminal may request network resources because it is a resident host attempting to establish its initial overall wireless connection between itself and the IP network. The mobile terminal may also request network resources because it is a handoff host attempting handoff from a prior wireless IP base station.

Regardless of whether the mobile terminal is a resident host or a handoff host, or whether the handoff method employed is hard handoff or soft handoff, the wireless IP base station receiving a network resource request from a mobile terminal must be able to allocate a sufficient amount of network resources in order to establish and maintain a wireless connection between the wireless IP base station and the mobile terminal. Network resources allocated for a mobile terminal may include an IP address necessary to establish and maintain a wireless connection, as well as bandwidth for the wireless connection that may carry voice and multimedia application information between the mobile terminal and the wireless IP base station. If sufficient network resources cannot be allocated to a requesting mobile terminal, then the quality of service for the mobile terminal will decrease, requests for a wireless connection may be denied, the handoff of the mobile terminal may fail, and the existing overall wireless connections may be terminated.

In order to allocate sufficient resources for resident and handoff hosts, the wireless network must reserve a sufficient amount of resources for these hosts. Thus, wireless IP networks employ a number of resource prediction methods that predict the future resource demands for network cells and their respective wireless IP base stations. Resource prediction methods determine the anticipated resource demands for resident and handoff hosts, thereby allowing a network cell and its wireless IP base station to reserve an appropriate amount of resources for handoff mobile terminals that will attempt to establish a wireless connection.

Resource prediction methods are constrained by a number of wireless IP network features, limitations, and goals when attempting to optimally predict resource demand. The main constraint on resource prediction methods is the ability to balance minimization of call blocking probability with inefficiency caused by over reservation of resources. Call blocking probability refers to the likelihood that a handoff host's wireless connection request will be denied because an insufficient amount of resources exists to serve the handoff host's wireless connection request. Whenever a wireless IP base station fails to provide the resources necessary to serve a handoff host's resource request, the quality of service for the handoff host will decrease. In particular, if a wireless IP base station has insufficient resources to create a new wireless connection for a handoff host, then the requested wireless connection is blocked, thereby increasing the probability that the handoff host's overall wireless connection will be terminated.

When predicting future resource demand, it is preferable to reserve resources for soft and hard handoff at the expense of resident hosts to minimize the handoff call blocking probability. If a wireless connection is blocked during soft handoff, then the overall wireless connection may still be maintained by the other wireless connections, but the quality of service will decline. If a wireless connection is blocked during hard handoff, then the overall wireless connection is terminated because only one wireless connection exists for hard handoff, and that wireless connection is blocked. If a wireless connection is blocked for a prospective resident host, then the initial wireless connection of a new mobile terminal is merely denied without terminating an existing overall wireless connection. Thus, it is preferable to reserve resources for handoff hosts in order to maintain existing overall wireless connections with a sufficient quality of service at the expense of denying new wireless connections for resident hosts.

In order to prefer handoff hosts over resident hosts, existing resource prediction methods tend to over predict resource demand for anticipated handoff hosts in order to guarantee that a sufficient amount of resources will be reserved for handoff hosts. Over prediction of handoff host resource demand, however, causes inefficiency within the wireless IP network and may itself lead to an increased call blocking probability for resident calls. First, as a greater amount of resources are reserved for anticipated handoff hosts, a corresponding amount of resources are unavailable for resident hosts. Thus, over prediction of handoff host resource demand increases the blocking probability for handoff hosts due to the over estimation of handoff host demand. Second, over prediction of handoff host and resident host network resource demand increases the blocking probability in other cells, because over prediction depletes IP network resources from the limited pool of total resources available to the entire wireless IP network. Thus, while under prediction of resource demand increases a cell's blocking probability, over prediction of resource demand decreases network efficiency and increases the blocking probability in other cells.

These call blocking probability and efficiency considerations highlight the need for resource prediction methods that precisely and accurately determine future resource demand. While over prediction of network resource demand is necessary, particularly for handoff hosts, any excess network resources reserved on the basis of over prediction impose inefficiency by the loss of otherwise available network resources. In contrast, the under prediction of network resource demands increases the blocking probability of both handoff and resident hosts while decreasing the quality of service. Thus, it is important to precisely and accurately predict the future network resource demands for both handoff and resident hosts.

Existing IP resource prediction methods encounter significant problems when attempting to precisely and accurately predict IP network resource demands within a wireless IP network, particularly for handoff hosts. First, the amount of bandwidth necessary for a handoff host in a wireless IP network has a large variance, can be arbitrarily large, and is sensitive to the bandwidth demands of mobile terminal applications. Second, wireless IP networks variably allocate resources according to network cell demand, such that high-data-rate cells or “hot spots” serve a greater number of high variance handoff host resource requests due to the heavy concentration of handoff hosts. Within these hot spots, the handoff of handoff hosts is more frequent and variable over extended periods of time, making it more difficult to predict handoff host IP network resource demand. Even in macrocellular networks, the handoff of handoff hosts is often non-Poisson and non-stationary for extended periods of time, making it difficult to predict network resource demand for handoff hosts.

These features of wireless IP networks make current resource prediction and reservation methods, whether global or local, undesirable for predicting handoff host network resource demands. Global resource prediction methods include local base stations that request global information from other base stations, and then predict local handoff host resource demand based on this global information. Global information requested from other base stations includes mobility patterns and traffic volumes in neighboring network cells, as well as expected handoff hosts that will be handed off from those cells to the requesting base station. These global prediction methods encounter a significant number of problems. First, collection of this global information is difficult due to the high handoff and variable data rates for handoff hosts. Second, collection of this global information increases overall system complexity and overhead, and is hampered by latency delays from information passing between base stations.

More recent local resource prediction methods use only local information to predict and reserve resources for a base station. These methods use a constant bandwidth for handoff hosts and a Poisson distribution for handoff host call arrival, and then predict resources based on these factors. In these local resource prediction methods, each base station measures the average rate of handoff within its cell, and then reserves radio channels for handoff hosts based on the average handoff rate. In these systems, an M/M/1 queuing model reserves the predicted number of radio channels by establishing an equivalent number of buffers in the M/M/1 queue. Although these local resource prediction methods avoid the high handoff rate and overhead problems associated with global resource prediction methods, these local IP resource prediction methods still encounter a number of significant problems.

First, the M/M/1 queuing model uses fixed buffers to predict and allocate resources, thereby limiting each radio channel to a fixed bandwidth size. This assumption of a fixed bandwidth size may be acceptable for voice-only IP networks, but is unacceptable for multimedia IP networks wherein the data-rate demands and bandwidth size for handoff hosts have a large variance attributable to different multimedia applications. Second, these models assume a Poisson interval for call arrival and an exponential service time for handoff hosts which do not necessarily hold true in multimedia IP networks.

Furthermore, even assuming it is appropriate to assume a constant bandwidth and average call arrival rate, determining the period of time used to calculate the average call arrival rate and bandwidth is difficult. Using a long period of time can significantly under predict the actual average call arrival rate, whereas using too short a period of time can over predict the actual average call arrival rate. Thus, these models are very sensitive to the time period chosen to calculate the average call arrival rate and bandwidth, which is an undesirable feature.

Some local resource prediction methods attempt to circumvent these problems by using moving averages to predict average call handoff rates and new call arrival rates. Other local resource prediction methods derive the average handoff call arrival rate from the new call arrival rate, thereby eliminating the need to measure the handoff call arrival rate.

These prior art methods can typically predict only average resource demands and cannot predict instantaneous resource demands.

Another local resource prediction method models the total amount of network resources R(t) necessary to support handoff calls at time “t” as a Wiener process. A Wiener process is a Markov process, which is a stochastic process wherein the future distribution of a variable depends only on the variable's present value. This is so because the present value of a variable depends on a past value, and each past value depends upon another past value. Thus, the variable's future distribution reflects its present distribution, which in turn reflects its past distribution.

For a standard Wiener process X(t), the change in the value of X(t) is defined as follows:

ΔX=X(t₂)−X(t₁)=α\sqrt{(t₂−t₁)}

ΔX is the change in the value of X(t) from time t₁ to t₂, X(t₂) is the value of the variable X(t) at time t₂, X(t₁) is the value of the variable X(t) at time t₁, and a is a standard normal variable. The standard Wiener process X(t) is a Markov process, and thus the time intervals Δt=(t₂−t₁) are independent, because each time interval takes reflects the effect of prior time intervals.

Prior art methods estimate handoff host IP network resources R(t) as a Wiener Process X(t), wherein

ΔR=R(t₂)−R(t₁)=α\sqrt{(t₂−t₁)}

ΔR is the change in the value of R(t), the amount of handoff host resources from time t₁ to t₂, R(t₂) is the value of the handoff host resources R(t) at time t₂, R(t₁) is the value of the handoff host resources R(t) at time t₁, and α is a standard normal variable. These methods assume a normal marginal distribution of the handoff rate of handoff hosts, and such an assumption becomes more justified as the handoff rate increases. The expected change in handoff resources E(ΔR)=0, because every incoming handoff host that enters a cell will ultimately leave the cell via handoff to another cell or termination of the mobile host's IP network connection. Nonetheless, there will be temporary fluctuations in the mean and standard deviation of the normal distribution of the handoff host resources due to temporary imbalances wherein the handoff of handoff hosts into the cell exceeds the handoff of the handoff hosts leaving the cell and vice versa. The Wiener models do not consider the correlation between past and future resource demands.

### SUMMARY OF THE INVENTION

These and other deficiencies in methods for estimating handoff host network resource demand are addressed by the present invention, which is a method for time series-based localized predictive resource reservation for handoff in multimedia wireless networks. The present invention models handoff host network resource demand as an Auto Regressive Integrated Moving Average (ARIMA) process, which is a variation of an Auto Regressive Moving Average (ARMA) process. An ARMA process is a combination of an autoregressive process and moving average process, and is used to forecast a time series of variables whose values may incorporate both a trend and seasonality.

An autoregressive process is a process wherein elements are serially dependant such that an element of the series can be estimated using a coefficient or set of coefficients multiplied by previous (time-lagged) elements of the series. This can be summarized in the following equation:

xₜ=ξₜ+φ₁xₜ₋₁+φ₂xₜ₋₂φ₃xₜ₋₃+ . . . φₚxₜ₋ₚ

In the autoregressive equation, xₜ is the value of the variable “x” at time “t,” xₜ₋₁, xₜ₋₂, xₜ₋₃, . . . are the previous “lagged” values of the variable “x” at 1 time unit before, 2 time units before, 3 time units before, . . . , respectively, φ₁, φ₂, φ₃, . . . φ_{P} are the autoregressive model parameters for a 1 time unit lag, 2 time unit lag, 3 time unit lag, . . . , respectively, and ξ is a constant intercept which represents random shock or error that occurs at time “t”. Thus, an autoregressive model of a time series {xₜ} essentially models a present value of the series xₜ as a linear sum of past values of the series xₜ₋₁, Xₜ₋₂, Xₜ₋₃, . . . multiplied by a set of autoregressive model parameters φ₁, φ₂, φ₃, . . . φₚ, respectively, plus a random shock value ξ.

In the autoregressive model, the number of autoregressive parameters is commonly referred to by the variable “p,” which is also called the order of the autoregressive model. Thus, an autoregressive model where p=1 is a first order model with only one autoregressive parameter φ₁, an autoregressive model where p=2 is a second order model with two autoregressive parameters φ₁ and φ₂, and so on. In order for an autoregressive model to remain stable, the autoregressive parameters φₓ must fall within a certain range; otherwise, the past effects of the model accumulate such that the value of xₜ approaches infinity. For instance, if p=1, there is only one autoregressive parameter φ₁, and |φ₁|<1 for a stable model. Autoregressive models that are stable and do not approach infinity due to the accumulation of past effects are referred to as stationary.

In contrast to an autoregressive process, a moving average process takes into account the fact that each element in a series is affected by past error. The effect of past error on each element in a series is summarized in the following equation:

xₜ=ξₜ+θ₁ξₜ₋₁+θ₂ξₜ₋₂+θ₃ξₜ₋₃+ . . . θ_{q}ξ_{t-q}

In the moving average equation xₜ is the value of the variable “x” at time “t,” ξₜ, ξₜ₋₁, ξₜ₋₂, >ₜ₋₃, . . . are the present and prior time lagged errors, and Θ₁, Θ₂, Θ₃, . . . are the moving average parameter models. Thus a moving average model of a time series {xₜ} essentially models a present value of the series xₜ as composed in part of a linear sum of past error values ξₜ₋₁,ξₜ₋₂, ξₜ₋₃, . . . ξₜ₋ₚ multiplied by a set of moving average model parameters Θ₁, Θ₂, Θ₃, . . . Θ_{q} respectively, plus the present error value ξₜ. The number of moving average model parameters is commonly referred to by the variable “q”. Thus, a moving average model where q=1 only has one moving average parameter Θ₁, a moving average model where q=2 has two moving average parameters Θ₁, and Θ₂, and so on.

An ARMA process combines the autoregressive and moving average models to describe a time series of observations expressed by a variable set {xₜ}. Thus, an ARMA process includes both autoregressive parameters and moving average parameters and is commonly referred to as an ARMA (p, q) model, where “p” refers to the number of autoregressive parameters and “q” refers to the moving average parameters. Thus, an ARMA (1, 2) process includes 1 autoregressive parameter and 2 moving average parameters. The equation for an ARMA (p, q) process can be summarized as follows:

xₜ−φ₁xₜ₋₁− . . . −φₚxₜ₋ₚ=zₜ+θ₁zₜ₋₁+ . . . +θ_{q}z_{t-q}

For the ARMA equation, {xₜ} is a set of observations from a stationary process, {zₜ} is a set of uncorrelated (white noise) random variables with a mean of zero and a variance σ² that represents error within the observations, φ₁ . . . φₚ are the autoregressive model parameters, and Θ₁ . . . Θ_{q} are the moving average parameter models. The ARMA (p, q) equation can be rewritten in the following fashion:

xₜ=(φ₁xₜ₋₁+ . . . +φₚxₜ₋ₚ)+(zₜ+θ₁zₜ₋₁+ . . . +θ_{q}z_{t-q})

Thus, the ARMA(p, q) equation is the linear sum of the autoregression and moving average equations, wherein the element xₜ is a linear combination of the autoregression of the prior observed elements and the moving average of the prior and current error elements. For the ARMA(p, q) equation, if p=0, then there is no autoregression component to the equation, and the ARMA(0, q) process is a pure moving average process. In contrast, if q=0, then there is no moving average component to the equation, and the ARMA(p, 0) process is a pure autoregression process.

By combining the autoregression and moving average models in an ARMA (p, q) model, the ARMA (p, q) model predicts future element values based on past values while filtering out noise included in past element observations. The autoregression portion of the model predicts future element values based on their correlation to past values, and thereby acts to model the relationship between past and future values. In contrast, the moving average portion of the model acts as a filter to eliminate error included in elemental observations.

Closely related to an ARMA process is an ARIMA process, which includes the autoregression and moving average processes, as well as a differencing process. An ARIMA process is expressed by an ARIMA equation commonly referred to as an ARIMA (p, d, q) equation. Within the ARIMA (p, d, q) equation, the variable “p” refers to the number of autoregressive parameters and the variable “q” refers to the number of moving average parameters. The additional variable “d” is the “lag” parameter specifying the number of differencing passes used to produce a stationary model that does not approach infinity due to the accumulation effects of prior elements. Thus, an ARIMA (1, 2, 3) process would include one autoregressive parameter, two lags or differencing passes, and three moving average parameters. An ARIMA process is a stationary process, meaning that the input time series for the ARIMA process has a constant mean, variance, and autocorrelation over time. Thus, the only significant difference between an ARMA and ARIMA process is the additional differencing pass step used to produce a stationary model.

The present invention models the amount of network resources R(t) necessary for the handoff of handoff hosts as an ARIMA process using an ARIMA (p,1,q) model. Equivalently, the present invention models the incremental change ΔR in the amount of network resources R(t) necessary for the handoff of handoff hosts as an ARMA process using an ARMA (p, q) model. By modeling the amount of network resources R(t) and ΔR necessary for the handoff of handoff hosts as an ARIMA and ARMA process, respectively, the present invention is able to directly predict the instantaneous amount of network resources necessary for the handoff of handoff hosts and reserve those resources in advance. Performing the prediction of R(t) using an ARIMA model provides a number of important benefits.

First, using an ARIMA model to predict mobile host network resource demand R(t) allows wireless IP cells and their base stations to perform local prediction of mobile host network resource demands without communicating with other cells and their wireless IP base stations. ARIMA processes rely on the principal that the future value of R(t) depends only on present and past values of R(t) irrespective of any other variables other than white noise error. Thus, using an ARIMA process and ARIMA(p,1,q) model to predict the amount of network resources necessary for the handoff of handoff hosts enables cells and their wireless IP base stations to locally predict handoff host network resource demand without any additional information from other cells and their wireless IP base stations. This feature greatly reduces cost and complexity and increases efficiency and reliability when predicting handoff host network resource demand.

Second, using an ARIMA model to predict handoff host network resource demand R(t) allows the present invention to directly model the handoff host network resource demand R(t), rather than indirectly model the handoff host network resource demand using an inaccurate multi-factor method. Multi-factor methods for predicting handoff host network resource demand require complex and imprecise estimation of numerous network factors in order to indirectly predict handoff host network resource demand. In contrast, the ARIMA model directly predicts handoff host network resource demand by relying upon past observations of handoff host network resource demand, thereby allowing a much simpler, efficient and accurate prediction.

Third, using an ARIMA model to predict handoff host network resource demand R(t) allows the present invention to determine the instantaneous handoff host network resource demand, rather than the average network host resource demand. Although prior art methods have used moving average models to predict handoff host network resource demand, these methods neglected the correlation of prior handoff host network resource observations and future handoff host network resource demands by omitting the autoregressive portion of the ARIMA model that correlates these prior and future mobile host network resource demands. In contrast, the present invention uses the ARIMA model and its autoregression feature to determine the instantaneous predicted value of handoff host network resource demand, thereby providing a more precise and accurate prediction of future handoff host network resource demand.

The present invention models handoff host network resource demand R(t) as an ARIMA (p,1,q) model using two basic steps common to all stochastic prediction methods. First, the present invention performs an identification and estimation phase wherein the necessary autoregressive and moving average variables “p” and “q,” respectively, are identified and the actual autoregressive and moving average parameters for the ARIMA (p,1,q) model are estimated. The present invention then proceeds to the forecasting phase, wherein the ARIMA(p,1,q) model constructed in the identification and estimation phase is used to predict future handoff host network resource demand R(t) based on past observations of handoff host network resource demand. Thus, by constructing an ARIMA (p,1,q) model to predict the handoff host network resource demand and then applying that ARIMA (p,1,q) model to predict future handoff host network resource demand, each cell and its wireless IP base station is able to accurately, precisely and efficiently predict and reserve a sufficient amount of handoff host and resident host network resources while reducing the call blocking probability for the handoff of handoff hosts.

### BRIEF DESCRIPTION OF THE DRAWINGS

The foregoing and other features of the present invention will be more readily apparent from the following detailed description and drawings of illustrative embodiments of the invention in which:

FIG. 1 is a diagram of a wireless IP network system;

FIG. 2 is a graph of actual, predicted and reserved bandwidth for handoff calls with uncorrelated demands; and

FIG. 3 is a graph of actual, predicted and reserved bandwidth for handoff calls with correlated demands.

### DETAILED DESCRIPTION

The first phase when modeling handoff host demand using an ARIMA (p,1,q) process is determining the autoregressive parameters φ₁ . . . φₚ and the moving average parameters Θ₁ . . . Θ_{q} based on local observations of handoff host demand at a wireless IP base station. In order to determine these parameters, the present invention first assumes that noise variables Zₜ . . . Z_{t-q} are normally distributed, thereby allowing the prediction not only of future handoff requests and handoff host network resource demand R(t), but also the confidence intervals for these forecasts.

By predicting the confidence intervals for the predicted handoff host network resources R(t), a high quality of service can be maintained by reserving the amount of predicted handoff host network resources R(t) at the upper confidence bound. Thus, wireless IP base stations may reserve the amount of handoff host network resources R(t) at the upper confidence bound necessary to maintain a high quality of service and grant the amount of handoff host network resources requested by handoff hosts. In addition, certain multimedia applications can tolerate a certain degree of quality of service degradation. Thus, wireless IP base stations may reserve the minimum required amount of handoff host network resources at the lower confidence bound rather than the actual requested amount of handoff host network resources at the upper confidence bound in order to lower the amount of reserved handoff host network resources while maintaining the same handoff call blocking probability.

A wireless IP base station determines the initial amount of handoff host network resources R(t) for the ARIMA (p,1,q) model by monitoring the amount of network resources requested by handoff hosts during an initial period of time to create an initial data set of handoff host network resource demand. This initial data set of handoff host network resource demand is generated by recording each of the handoff network resource demands during an initial period of time. During this time, either no resource reservation is performed, or resource reservation levels are set to the last recorded resource demand at regularly or variably spaced update intervals. This initial period can end after enough data has been collected to fit a specific ARIMA (p,1,q) model. Typically, 25 samples are sufficient for estimating the parameters. If p=q=0, then the ARIMA (p,1,q) model reduces to the Wiener model, and the initial period can end after our sample estimate of the resource request variance stabilizes.

The initial data set is due to determine an ARIMA(p,1,q) model for the total resources R(t), or equivalently and ARMA(p, q) model for ΔR(t), the change in aggregate handoff host network resource demand. To do this, first the orders p and q need to be determined. This can be done using an information theoretic criterion such as the bias-corrected Akaike Information Criterion (AICC) or a Bayesian variant of this, the BIC. Both criteria try to minimize the final prediction error, while attempting to keep the order of the ARMA (p, q) model low. This procedure can be fully automated. After determination of p and q, we can use standard estimation methods such as maximum likelihood estimation to fit the parameters f₁, . . . , fₚ and q₁, . . . q_{q}. As default model, we can use either a Wiener model (p=q=0), a purely auto regressive AR(p) model (q=0), or a ARMA (p, p) model, with p small. An AR (p) model can be fit quickly and efficiently via the Yule Walker method, which has the nice property that the first p lags of auto correlation function of the fitted AR(p) model match the first p lags of the sample auto correlation function exactly.

The initial data set of handoff host network resource demand is also used to determine an ARIMA (p,1,q) model used to determine ΔR, the change in handoff host IP network resource demand. The resulting ARIMA (p,1,q) model can be used to recursively predict the next resource request levels, and provide 95% upper confidence levels for these requests. Typically, we will choose the prediction horizon as short as possible, for instance 1 minute in the future. This is because the longer the prediction horizon, the wider the resulting confidence interval for the resource requests, and the more conservative the upper confidence level will be.

Once the ARIMA (p,1,q) model and initial handoff host network resource demand R(t) have been determined, the process can proceed to the second phase wherein the future handoff host IP network resource demand R(t) is predicted based on the initial handoff host network resource demand R(t) and the predicted change in handoff host network resource demand ΔR. The ARIMA (p,1,q) model is used to determine the change in handoff host network resource demand ΔR from the initial handoff host network resource demand R(t) to determine the future handoff host network resource demand, as well as further incremental changes in handoff host network resource demand ΔR beyond the initial demand. Based on the ARIMA forecasts, any method may be used to determine the actual reservation level. For example, we can forecast the amount of resources required for handoff calls Cn(t), and the amount of resources for new calls Cn(t) for the next time period (of e.g. 1 minute). Let the total resource capacity be C. If Cₙ(t)+Cₕ(t)≦C, then no resources are reserved. If Cₙ(t)+Cₕ(t)>C, then the minimum of Cₕ(t) and C is reserved for handoff calls. In practice, this reservation scheme can be implemented as follows: when a resident call which entered the cell as a new call leaves, the resources it occupied will be freed if the total pool of handoff capacity exceeds Cₕ(t), otherwise they are reserved for future handoff calls. Thus, the wireless IP base station is able to reserve the amount of handoff host network resources necessary to serve the predicted amount of handoff host network resources.

As the ARIMA (p,1,q) model is used to predict the future handoff host network resource demand, estimation error may accumulate over time and require redetermination of the ARIMA (p,1,q) model used to predict future handoff host network resource demand. In order to eliminate this accumulation error, each base station records the actual amount of resources R(t) required for handoff hosts periodically and uses these observations to reset the ARIMA (p,1,q) model. The reset process can be implemented as follows: As long as the forecast error is within 3 standard deviations of the forecast error so far (e.g., any other criteria of choice), the estimated ARIMA (p,1,q) model is unchanged, and new forecasts are computed by just using the recent observations. If the forecast error exceeds 3 standard deviations, then a new ARIMA (p,1,q) model is computed. Alternatively, a fully new ARIMA (p,1,q) model is computed based on the handoff arrivals in the last 25-30 minutes every minute.

In addition, significant changes in actual handoff host resource demand may also trigger a reset of the ARIMA (p,1,q) model independent of the periodic observations taken to eliminate error accumulation. These changes may be detected using statistical quality control techniques. These significant changes also signal the wireless IP base station to collect handoff host resource demand information more frequently.

The method of the present invention which includes an ARIMA (p,1,q) model to determine future handoff host network resource demand has been tested to evaluate its performance for predicting the total amount of bandwidth required to support handoff hosts of multiple service types. These tests demonstrate the performance of a single wireless IP base station cell when predicting handoff host network resource demand using an ARIMA (p,1,q) model according to the present invention.

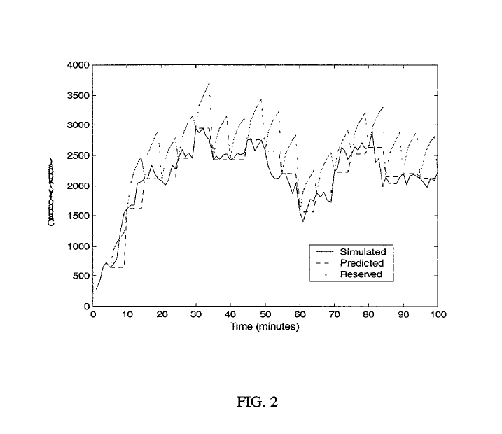

FIG. 2 shows a graph of the test results of actual, predicted and reserved bandwidth for handoff hosts with uncorrelated demands using the present invention ARIMA (p,1,q) model to predict handoff host network resource demand. This test reflects the features of an actual wireless IP network. For example, a wireless IP network may support voice services at 16 kbps, Internet access services at data rates from 16 kbps-56 kbps, and real-time video services at 384 kbps. Furthermore, the majority of handoff hosts use Internet access services, with a small percentage of real-time video service users.

These features are reflected in uncorrelated handoff hosts, in which the handoff host IP process is Poisson, but the arrival and departure of handoff hosts are assumed to be uncorrelated as in prior art methods. In this model, the requisite bandwidth to successfully handoff a handoff host is 16 kbps-56 kbps. There is a 10% probability that a very high bandwidth 384 kbps handoff host is handed off into the cell each minute. Each handoff host remains active in the cell and bandwidth requirements and holding times for different handoff hosts are independent.

Referring now to FIG. 2, therein is shown the simulated, predicted and reserved bandwidth for handoff calls with uncorrelated demands based on the model described above. FIG. 2 assumes that λ=5 handoffs per minute, 1 is the mean handoff rate, with a handoff host network resource prediction interval Δt=1 minute, and an ARIMA (p,1,q) update parameter T_{update}=5 minutes. Thus, starting at time t=0, the handoff host network resource demand for the next minute is predicted based on the actual or predicted demand for handoff hosts during the prior minute (Δt=1 minute). Furthermore, the ARIMA (p,1,q) model is reset to the actual bandwidth requirements for handoff hosts once every five minutes (T_{update}=5 minutes).

The simulated amount of IP network resource bandwidth shown in FIG. 2 is the actual amount of IP network resource bandwidth required to handoff the handoff hosts as determined by the simulation. The predicted amount of network resource bandwidth shown in FIG. 2 is the amount of network resource bandwidth as determined by the ARIMA (p,1,q) model of the present invention to predict the amount of network resource bandwidth necessary to handoff the anticipated handoff hosts. The reserved amount of network resource bandwidth shown in FIG. 2 represents the 97.5% confidence bound of the ARIMA (p,1,q) prediction, and represents the reservation level of network resource bandwidth based on the ARIMA (p,1,q) model prediction.

As shown, the predicted network resource bandwidth requirements under the ARIMA (p,1,q) model closely follow the simulated network resource bandwidth requirements according to the model. Furthermore, the reserved amount of network resource bandwidth requirements according to the ARIMA (p,1,q) model always exceeds the simulated amount of network resource requirements. These results for the uncorrelated handoff host simulation coincide with those results for the prior art Weiner process prediction methods for handoff host network resource demand. New results show the significant differences between the prior art Wiener model and the ARIMA (p,1,q) simulation results more clearly: In this simulation, we fitted in particular an ARIMA(p, 1, 0) model, using the Yule Walker method.

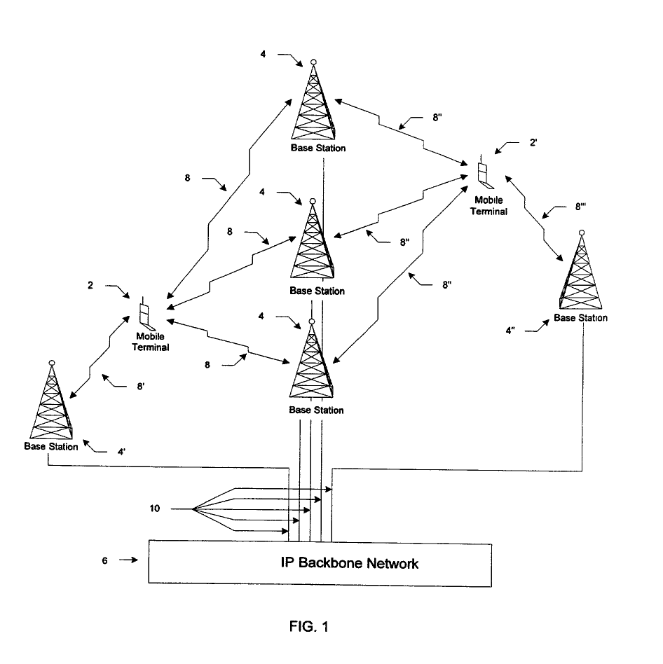

For the following simulated resource demands, shown in FIG. 1, we have computed the predicted Wiener and ARIMA(p, 1, 0) 95% upper confidence levels. These are also shown in FIG. 1. In FIG. 2, we show the time series of difference (Wiener prediction)—(ARIMA prediction). This Figure highlights a key difference between the ARIMA(p,1,q) prediction and the Wiener prediction: ARIMA(p,1,q) is better able to track the steady decrease in aggregate handoff resource demands near the end of the series (after about 200 minutes in FIG. 1). Therefore, it over reserves much less than Wiener prediction, which leaves more capacity for admitting new calls.

In the stationary part of the time series, the difference is often very close to 0. This is because the estimated ARIMA(p, 1, 0) model had p=q=0, or p small, but the estimated coefficients f₁ . . . , fₚ nearly 0.

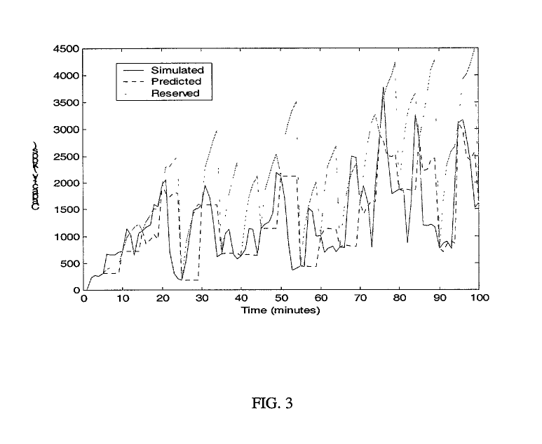

FIG. 3 shows a graph of the test results of actual, predicted and reserved bandwidth for handoff calls with correlated demands using the present invention ARIMA(p,1,q) model to predict handoff host network resource demand. In this correlated simulation, the handoff interval of handoff hosts is modeled as an AR(1) process. An AR(1) process is an Auto Regressive process of order 1, in other words: an ARMA(1, 0) model. Using AR(1) model to describe the handoff interarrivals is a straightforward way to model a dependent interarrival process. Field data are not available to test the appropriateness in practice. The AR(1) process is constructed to have mean ⅕, i.e. 5 handoffs/minute, and the noise variables Xₜ have an exponential distribution. This is again a theoretical assumption. Wherein φ₁=0.5, the mean =⅕, and the mean is driven by exponential random variables.

The call holding times are also modeled as an AR(1) process wherein φ₁=0.5, the mean =10 minutes, and the mean is driven by Pareto random variables with a tail index =1.5. Similar reasoning holds for the holding time distribution. A Pareto distribution is chosen because the holding time for data bursts sent/received by a mobile data user are well modeled by this distribution. In fact, the results are almost insensitive to the particular holding time distribution chosen. The Pareto random variable model is selected to reflect the fact that most handoff hosts are for Internet access, for which the call holding time distribution often has a heavy tail. A real life situation in which arrivals are dependent can occur when mobiles arrive in close sequence, for instance because users are inside a bus or train, which suffers traffic delay.

Handoff bandwidth demands are modeled as an AR(2) process wherein φ₁=0.18 and φ₂=0.11. An AR(2) process is an Auto Regressive process with order p=2, that is: an ARMA(2, 0) model. It is again a straightforward method of modeling (small) dependence in the handoff bandwidth. The dependence between handoff demands is modeled as less than the dependence between handoff interarrivals and holding times, but different users are still assumed to influence each others chosen application mildly. Again: no field data exists to validate these assumptions. Bandwidth requirements are still modeled as 16 kbps-56 kbps for voice and Internet access and 384 kbps for real-time video services. There is a 10% probability that a very high bandwidth 384 kbps handoff host is handed off into the cell each minute, and a 90% probability that a normal bandwidth 16 kbps-56 kbps handoff host is handed off into the cell each minute.

Referring now to FIG. 3, therein is shown the simulated, predicted and reserved bandwidth requirements for the handoff of correlated handoff hosts from the simulation model above using the ARIMA (p,1,q) model of the present invention to predict and reserve network resources. The simulated amount of IP network resource bandwidth shown in FIG. 3 is the actual amount of network resource bandwidth required to handoff the handoff hosts as determined by the simulation. The predicted amount of IP network resource bandwidth shown in FIG. 3 is the amount of network resource bandwidth as determined by the ARIMA (p,1,q) model of the present invention to predict the amount of network resource bandwidth necessary to handoff the anticipated handoff hosts. The reserved amount of network resource bandwidth shown in FIG. 3 represents the 97.5% confidence bound of the ARIMA (p,1,q) prediction, and represents the reservation level of network resource bandwidth based on the ARIMA (p,1,q) model prediction.

When comparing the correlated simulation results of FIG. 3 to the uncorrelated simulation results of FIG. 2, the first difference is that the simulated bandwidth demands from the correlated simulation of FIG. 3 are considerably more bursty than the simulated bandwidth demands from the uncorrelated simulation of Fig. The burstiness reflects the dependence of the handoff arrivals, which can occur in the previously described fashion.

Comparing the correlated simulation results of FIG. 3 to prior art Wiener prediction method results, the mean absolute difference between the predicted and actual handoff network resource demand is 478.9 kbps±502.4 kbps for the ARIMA (p,1,q) prediction, as compared to 508.0 kbps±565.3 kbps for the prior art Weiner prediction. Thus, there is a smaller difference and variance between the predicted network resource demand and actual network resource demand for the ARIMA (p,1,q) model as compared to the prior art Wiener model. The absolute difference between the reservation levels and the actual demand is 854.4 kbps±909.1 kbps for the ARIMA (p,1,q) prediction, as compared to 916.1 kbps±994.0 kbps for the prior art Weiner prediction. Thus, there is also a smaller difference and variance between the reserved network resource demand and actual network resource demand for the ARIMA (p,1,q) model as compared to the prior art Wiener model. The reservation levels overshoot 11 out of 96 times for the ARIMA (p,1,q) prediction as compared to 10 out of 96 times for the prior art Weiner prediction, which is a minimal difference that drops considerably when the longer startup time for the ARIMA (p,1,q) model is taken into account. In sum, the ARIMA (p,1,q) method of the present invention predicts and reserves the amount of IP network resource bandwidth demand more accurately and precisely than the prior art Weiner methods.

The example used to illustrate the benefits of this invention concerns bandwidth demand, but the method can also be used for the amount of IP addresses necessary for handoff host without modifications. In this case, the resource demand is simply the number of IP addresses required, and ARIMA(p,1,q) modeling is used to forecast confidence levels for these demands.

While the invention has been particularly shown and described with reference to one embodiment thereof, it will be understood by those skilled in the art that various changes in form and details may be made therein without departing from the spirit and scope of the invention.

We claim:

1. A method for an IP wireless cell and its base station in an IP wireless network locally to predict mobile host network resource demands without communicating with other IP cells and their wireless base stations comprising using an ARIMA model.

2. The method of claim 1 wherein said ARIMA model is an ARIMA (p,1,q) model and further comprising the step of performing an identification and estimation phase wherein the autoregressive variable “p” and the moving average variable “q” are identified and the actual autoregressive and moving average parameters for the ARIMA (p,1,q) model are estimated.

3. The method in accordance with claim 2 further comprising applying the ARIMA (p,1,q) model to predict the future handoff host resource demand.

4. The method in accordance with claim 3 wherein said performing step is performed at a wireless base station based upon local observations of handoff demand.

5. The method in accordance with claim 4 wherein said performing step includes the step of monitoring the amount of network resources requested by handoff hosts during an initial period of time to create an initial data set of handoff host IP network resource demand R(t).

6. The method in accordance with claim 5 further comprising the step of using the initial data set of handoff host network resource demand R(t) to determine the change in handoff network resource demand ΔR

7. The method in accordance with claim 6 further comprising predicting the future handoff host network resource demand based on the initial host network resource demand R(t) and the predicted change in handoff host network resource demand ΔR.

8. The method in accordance with claim 1 comprising using both an ARIMA model and an ARMA model.
